(19) United States
(12) Patent Application Publication
(10) Pub. No.: US 2026/0178813 A1
(43) Pub. Date: Jun. 25, 2026

(54) METHOD OF DEVICE DESIGN INCLUDING RESISTANCE ESTIMATION

(71) Applicant: TAIWAN SEMICONDUCTOR MANUFACTURING COMPANY, LTD., Hsinchu (TW)

(72) Inventors: Chih-Hsing LIN, Hsinchu (TW); Yuan-Chia HSU, Hsinchu (TW)

(21) Appl. No.: 18/999,915

(22) Filed: Dec. 23, 2024

(51) Int. Cl. G06F 30/398; G06F 30/3953; G06F 119/12

(52) U.S. Cl. CPC G06F 30/398; G06F 30/3953; G06F 2119/12

(57) ABSTRACT

A method of evaluating resistance in an integrated circuit (IC) device design includes identifying a conductive structure in the IC device design; identifying one or more regular patterns in the conductive structure; partitioning the one or more regular patterns from one or more remaining portions of the conductive structure, the one or more remaining portions being one or more irregular patterns; for the one or more regular patterns and the one or more irregular patterns: determining a rotation angle of the pattern; slicing the pattern, in a direction perpendicular to the rotation angle, into one or more polygons; and summing individual resistances of each of the one or more polygons to provide a resistance of the pattern; and summing the resistances of the one or more regular patterns and the one or more irregular patterns to provide an estimated resistance of the conductive structure.

### BACKGROUND

Integrated circuit (IC) devices are becoming increasingly complex. The increasing complexity presents challenges in predicting device characteristics from an IC device design. An accurate understanding of properties of components of an IC device design is useful for designing an IC device and for accurately predicting characteristics of a final device.

### BRIEF DESCRIPTION OF THE DRAWINGS

FIG. 1A is a perspective view of a conductive structure of an integrated circuit (IC) device design according to some embodiments, and FIG. 1B is a plan view of the conductive structure according to some embodiments.

FIG. 2A is a flowchart of a method of estimating resistance of a conductive structure according to some embodiments.

FIG. 2B is a flowchart of operations in a method of estimating resistance of a conductive structure according to some embodiments.

FIGS. 3A-1 and 3A-2 are examples of slicing a regular pattern according to some embodiments.

FIGS. 3B-1 and 3B-2 are examples of slicing an irregular pattern according to some embodiments.

FIG. 3C is an example of slicing directions in partitioning a conductive structure according to some embodiments.

FIGS. 4A and 4B are examples of partitioning a conductive pattern according to some embodiments.

FIGS. 5A-1, 5A-2, and 5A-3 are examples of resistance estimation of irregular patterns according to some embodiments.

FIGS. 5B-1, 5B-2, and 5B-3 are examples of resistance estimation of patterns according to some embodiments.

FIG. 6 is an example of resistance estimation of a Manhattan pattern according to some embodiments.

FIGS. 7A and 7B are examples of resistance estimation for unrotated and rotated patterns according to some embodiments.

FIG. 7C is an example of estimating resistance for a complex conductive structure having portions that are rotated at two different non-zero angles.

FIG. 7D is an example of estimating resistance for teardrop, stadium, and Manhattan-shaped patterns.

FIG. 8 is a block diagram of an electronic design automation (EDA) system according to some embodiments.

FIG. 9 is a block diagram of an integrated circuit (IC) manufacturing system, and an IC manufacturing flow associated therewith according to some embodiments.

### DETAILED DESCRIPTION

The following disclosure provides many different embodiments, or examples, for implementing different features of the provided subject matter. Specific examples of components, values, steps, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

With increasing demand for 3D integrated circuits, there is a trend to increase the number of irregular, e.g., non-Manhattan-shaped, conductive connections in device designs. In some embodiments, a conductive structure, such as a three-dimensional (3D) conductive structure in an IC device design, is efficiently and accurately modeled to estimate resistance of the conductive structure and provide reference resistance data, e.g., to an EDA tool, in a development stage of an IC device design and before silicon data is available. Advantageously, embodiments provide for resistance estimation that is accurate and consistent for both complex or irregular conductive structures and simple or regularly-shaped conductive structures, in a manner that is substantially or completely unaffected by an angle of rotation of the conductive structures or portions thereof. In some embodiments, accurate estimated resistance values are provided for various irregular shapes and angles before obtaining silicon data, which allows development tools to adjust based on these reference values during development, avoiding the need to wait for silicon data verification and thus shortening the development and verification cycles of an IC device or the like.

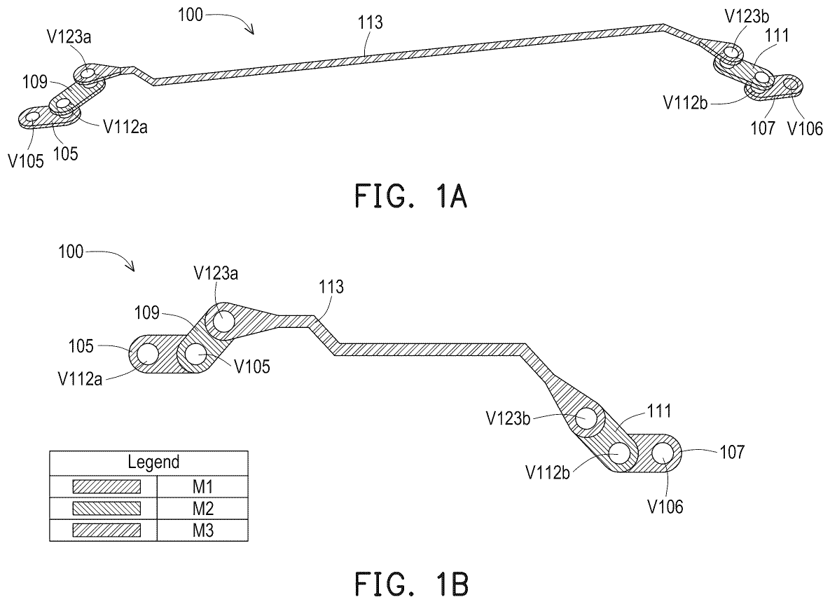

FIG. 1A is a perspective view of a conductive structure 100 of an integrated circuit (IC) device design according to some embodiments, and FIG. 1B is a plan view of the conductive structure 100 according to some embodiments.

In designing an IC device, it is important to have accurate information regarding characteristics of structures such as the conductive structure 100 that form parts of the IC device design. The accurate estimation of characteristics such as resistance helps enable accurate prediction and optimization of circuit behavior, such as timing, device behavior, such as heating during operation, and operation-related changes that can affect device lifetime, such as electromigration. Depending on the nature of a circuit that includes the conductive structure 100, the resistance of the conductive structure 100 can impact signal timing (e.g., delay) of the circuit. If the resistance is too high, it can lead to a decrease in the performance of the circuit or cause a performance target to be lowered for the circuit design. Also, if the resistance cannot be accurately estimated, the performance of the circuit design may not be clearly understood before the circuit design is actually fabricated and tested. Early and accurate estimation of resistance of the conductive structure 100 can thus enable faster, more accurate, and less expensive design operations for a circuit that includes the conductive structure 100.

Embodiments are described herein in the context of a conductive structure in an IC device design. In some embodiments, the conductive structure is in dielectric layers, e.g., interlayer dielectric layers or intermetal dielectric layers, in an IC device, e.g., a semiconductor die, a system on chip (SoC), or the like. In some other embodiments, the conductive structure extends between IC devices, e.g., between dies or packages in a 3D IC, a multi-chip package, or the like. In some other embodiments, the conductive structure is in an interposer, redistribution layer (RDL), or the like. In some embodiments, the conductive structure is configured to carry a signal, e.g., a signal applied to a gate of a transistor or a signal gated by or controlled by a transistor. In some embodiments, the conductive structure is configured to carry a power or ground voltage, e.g., VSS, VDD, or the like. Embodiments are also applicable to other device designs that include conductive structures, such as wiring, resistors, electrodes, or the like, for which an accurate estimate of resistance of the conductive structure is desired. Some embodiments are described herein in the context of predicting resistance of a conductive structure in an IC device design but embodiments are also applicable to other aspects of device design and manufacturing, e.g., predicting other shape-dependent or size-dependent characteristics of a structure, conductive or otherwise, in an IC device design, predicting resistance of a conductive structure in a fabricated IC device, and the like.

In FIGS. 1A and 1B, the conductive structure 100 includes conductive portions on three conductive layers, the conductive portions being connected together by four vias. As described in detail herein, in some embodiments the conductive structure 100 is partitioned to estimate resistance of different portions of the conductive structure 100 and combine the estimated resistances of the portions to provide an estimate of the resistance of the conductive structure 100 as a whole.

The conductive structure 100 in FIGS. 1A and 1B including conductive portions on three conductive layers is merely an example, and embodiments can be applied to a conductive structure that includes conductive portions on only one conductive layer, on two conductive layers, on more than three conductive layers, or the like. Further, embodiments can be applied to a conductive structure that includes multiple vias, one via, or no vias. The conductive structure can extend in, e.g., one, two, or three dimensions in the device design being evaluated. In some embodiments, a conductive structure or pattern for which resistance is to be estimated is a continuous and uninterrupted structure or pattern.

In FIGS. 1A and 1B, the conductive structure 100 includes a first conductive portion 105 and a second conductive portion 107 located at or formed in a first conductive layer M1.

In some embodiments, the first conductive layer M1 is a metal or metal element-containing layer. However, embodiments can be applied to conductors other than metal or metal-element containing conductors, e.g., carbon-based conductors, semiconductor-based conductors, or the like. The term “metal layer” is used herein in a generic sense to encompass any suitable electrical conductor.

Further, the term “first” in first conductive layer M1 is merely for the sake of reference relative to other portions of the conductive structure 100 and does not imply a particular layer in an integrated circuit (IC) containing the conductive structure 100. A “first” layer can have other layers between the “first” layer and a substrate, i.e., the “first” layer is not required to be a lowermost layer. Similarly, references to “first,” “second,” “third,” and the like do not imply an order of layers or an order of connections. For example, a “second” layer herein can be above or below a “first” layer.

In FIGS. 1A and 1B, the conductive structure 100 includes a third conductive portion 109 and a fourth conductive portion 111 located at or formed in a second conductive layer M2. The first conductive portion 105 in the first conductive layer M1 is electrically connected to the third conductive portion 109 in the second conductive layer M2 by a first via V112a. The second conductive portion 107 in the first conductive layer M1 is electrically connected to the fourth conductive portion 111 in the second conductive layer M2 by a second via V112b.

The first and second vias V112a, V112b in FIGS. 1A, 1B have circular aspects in plan view. In some other embodiments, the first and second vias V112a, V112b, as well as other vias described herein, have aspects that are rectangular, square, polygonal, or the like. Further, some vias have different aspects from other vias in some embodiments. The vias are formed of any suitable electrical conductor.

In FIGS. 1A and 1B, the conductive structure 100 includes a fifth conductive portion 113 located at or formed in a third conductive layer M3. The third conductive portion 109 in the second conductive layer M2 is electrically connected to the fifth conductive portion 113 in the third conductive layer M3 by a third via V123a. The fourth conductive portion 111 in the second conductive layer M2 is electrically connected to the fifth conductive portion 113 in the third conductive layer M3 by a fourth via V123b.

In FIGS. 1A and 1B, the conductive structure 100 is connected at opposite ends thereof, by a fifth via V105 and a sixth via V106, to other elements of the integrated circuit in which the conductive structure 100 is included. In some embodiments, the fifth via V105 and the sixth via V106 correspond to pins, e.g., input or output pins, of a circuit.

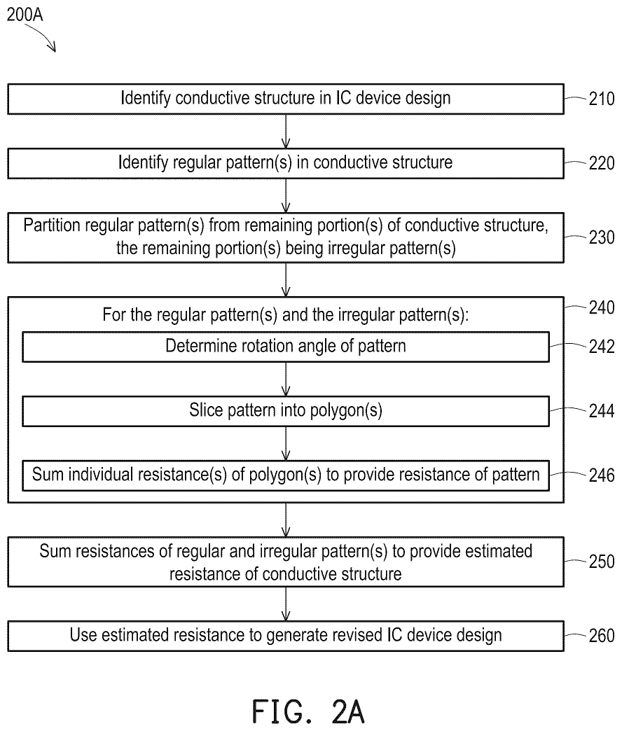

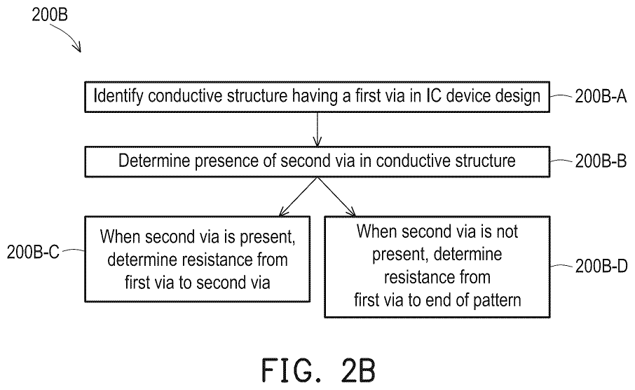

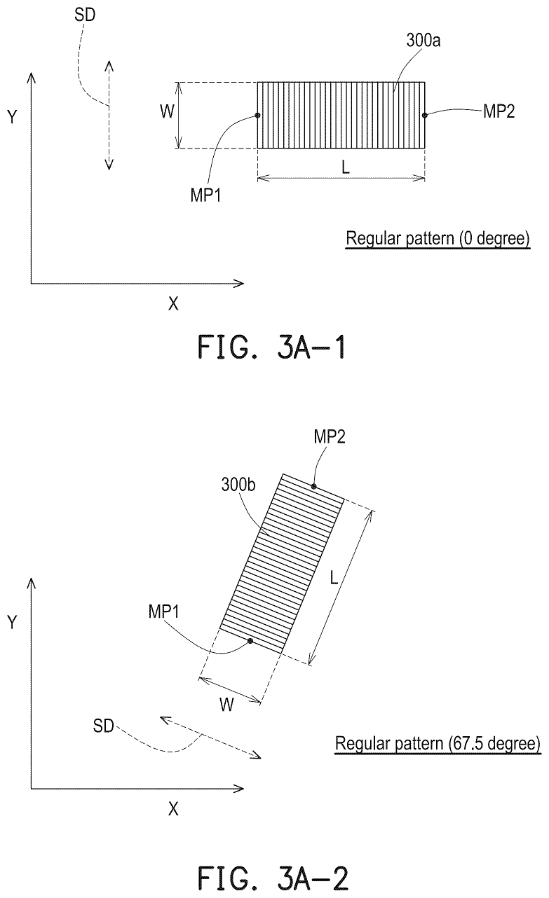

FIG. 2 is a flowchart of a method 200A of estimating resistance of a conductive structure according to some embodiments.

In FIG. 2, the method 200A includes operations 210, 220, 230, 240, 250, and 260.

Operation 240 includes operations 242, 244, and 246. Although the various operations are described as being performed in sequence in some embodiments, an order of operations is changed to be nonsequential for one or more operations in some embodiments.

In the method 200A, a conductive structure is identified in an IC device design in operation 210. An example of the conductive structure that is identified in the IC device design in operation 210 is the conductive structure 100 described in connection with FIGS. 1A and 1B.

In operation 220, the conductive structure is analyzed to identify one or more regular patterns therein. As discussed in further detail below, an example of a regular pattern is a Manhattan pattern. A Manhattan pattern is a pattern or a portion of a conductive structure that is used to implement Manhattan routing, e.g., of interconnects or the like, in a device such as an IC device. In some embodiments, a pattern is considered to be a regular shape (e.g., a Manhattan shape) when the pattern has a constant width. In some embodiments, a regular pattern is partitioned from an irregular pattern where the width changes or stops being constant.

In operation 230, the conductive structure is partitioned to separate the regular pattern (or patterns) from a remaining portion (or portions) of the conductive structure. In some embodiments, the remaining portion (or portions) are designated as irregular patterns. In some embodiments, the remaining portion (or portions) are further partitioned. For clarity, aspects of the partitioning are described in some cases herein with reference to a singular pattern, portion, or the like, but it will be understood that the singular also encompasses the plural, i.e., such references encompass plural patterns, portions, or the like in some embodiments. Conversely, aspects that are described with reference to plural patterns, portions, or the like will be understood to also encompass the singular, i.e., a singular pattern, portion, or the like.

In operation 240, resistance estimates are made for the regular and irregular patterns. Estimating the resistance for a pattern includes determining a rotation angle of the pattern (operation 242), slicing the pattern into one or more polygons (operation 244), and summing individual resistances of the polygons to provide a resistance estimate for the pattern (operation 246). In some embodiments, the slicing the pattern into one or more polygons (operation 244) includes slicing the pattern into one or more polygons having two sides perpendicular to the rotation angle, e.g., polygons such as rectangles, squares, trapezoids, parallelograms, or the like. In some embodiments, it is assumed that a distribution of current flow in a pattern is evenly distributed through the pattern.

In operation 250, the resistances of the regular and irregular patterns are summed to provide an estimated resistance of the conductive structure that was identified in operation 210. In some embodiments, a resistance of a via is considered to be accounted for by the summed resistances of the regular and irregular patterns. In some other embodiments, a resistance of a via is added as a separate resistance component to the summed resistances of the regular and irregular patterns.

In operation 260, the resistance of the conductive structure is used to generate a revised IC device design. In some embodiments, such revisions include, e.g., modifying the conductive structure itself, modifying other circuit or device elements that include or are adjacent to the conductive structure, setting or modifying anticipated circuit performance characteristics such as signal timing, setting or modifying testing metrics, and the like. In some embodiments, the revised IC device design is sent to tape out and then a device is fabricated therefrom. In some embodiments, the revised IC device design is further modified or the IC device design process iterates, and the revised IC device design is again analyzed to estimate resistance of one or more conductive structures in the revised IC device design.

FIG. 2B is a flowchart of operations in a method 200B of estimating resistance of a conductive structure according to some embodiments.

In FIG. 2B, the operations in the method 200B include operations 200B-A, 200B-B, 200B-C, and 200B-D. In some embodiments, the operations 200B-A, 200B-B, 200B-C, and 200B-D are followed by one or more of operations 240, 250, and 260 of method 200A.

In some embodiments, a conductive structure includes one or more vias. In some embodiments, vias have a circular component in their appearance. In method 200B, a conductive structure is identified in an IC device design in operation 200B-A by identifying a via in the conductive structure. An example of the conductive structure that is identified in the IC device design is the conductive structure 100 described in connection with FIGS. 1A and 1B. In some embodiments, the via is identified by detecting a circular component in the appearance of the conductive structure. In some embodiments, a centerpoint of the circular component is determined as a center of the via. In some embodiments, detecting the via centerpoint and slicing or dividing a pattern from the via centerpoint significantly increases the speed and efficiency of the resistance estimation process, e.g., as compared to dividing an entire pattern and then determining ranges or regions of the pattern for which resistances are to be estimated and summed.

In operation 200B-B, it is determined whether a second via is present in the conductive structure. In some embodiments, the second via is identified by detecting a second circular component in the appearance of the conductive structure. In some embodiments, a centerpoint of the second circular component is determined as a center of the second via.

In some embodiments, a pattern includes one via and resistance of the pattern is estimated based on a distance from the via centerpoint to an edge of the pattern. In some other embodiments, the pattern includes two vias and resistance of the pattern is estimated based on a distance from one via centerpoint to the other via centerpoint, e.g., based on X- and Y-axis positions of the via centerpoints. In some embodiments, the distance (from via centerpoint to edge or via centerpoint to via centerpoint) is divided or sliced into polygons based on a minimum width value in a model or a Raphael table.

In operation 200B-C, for the case in which the second via is present in the conductive structure, resistance of the conductive structure is determined (i.e., estimated) from the first via to the second via, e.g., from the center of the first via to the center of the second via.

On the other hand, in operation 200B-D, for the case in which a second via is not present in the conductive structure, resistance of the conductive structure is determined from the first via to an edge of the conductive structure, e.g., from the center of the first via to the edge of the conductive structure.

In some embodiments, operations 200B-C and 200B-D include slicing the conductive structure into polygons starting from the first via. In some embodiments, the slicing is performed in a regular manner throughout the IC device design, e.g., from left-to-right starting from the first via, e.g., starting from the center of the first via or leftmost via.

In some embodiments, one or more operations of methods 200A and 200B are combined. For example, in some embodiments operation 210 of method 200A includes the feature of identifying a conductive structure having a first via of operation 200B-A of method 200B. As another example, in some embodiments method 200A determines resistance of the conductive structure from a first via to a second via, e.g., from the center of the first via to the center of the second via, for a conductive structure having first and second vias. As another example, in some embodiments method 200A includes slicing patterns in a regular manner throughout the IC device design, e.g., from left-to-right starting from a first via or leftmost via, e.g., starting from the center of the first via.

In some embodiments, method 200A and/or method 200B includes an operation of partitioning the conductive structure by layer, e.g., partitioning the conductive structure according to the conductive layers M1, M2, and M3 described above. In some embodiments, partitioning the conductive structure by layer is performed before partitioning the regular and irregular patterns of the conductive structure. In some other embodiments, partitioning the conductive structure by layer is performed after partitioning the regular and irregular patterns of the conductive structure.

FIGS. 3A-1 and 3A-2 are examples of slicing a regular pattern according to some embodiments.

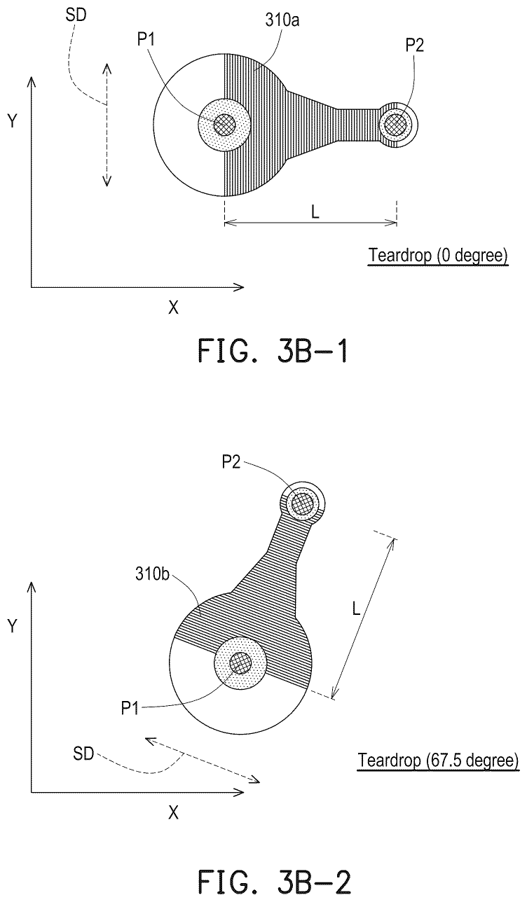

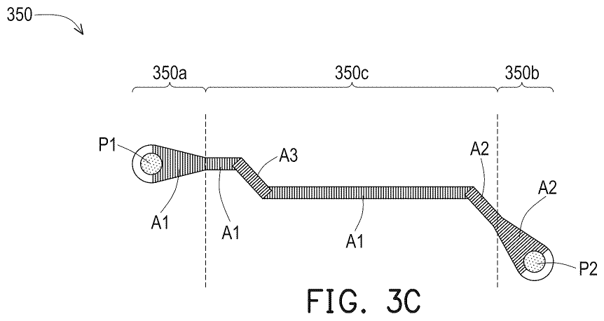

In FIG. 3A-1 a regular pattern 300a has an axis of rotation that is rotated at an angle of zero degrees (0° of rotation) (herein, unless stated otherwise, rotation is stated relative to horizontal, which in FIGS. 3A-1 and 3A-2 is the X axis). The regular pattern 300a may be referred to as an unrotated pattern. In FIG. 3A-2, a regular pattern 300b has an axis of rotation that is rotated at an angle of 67.5°, by way of example. Embodiments are not limited to a particular angle of rotation, and are applicable to patterns that are not rotated or have an arbitrary angle of rotation.

In another approach in which a 67.5°-rotated pattern is sliced vertically, an estimated resistance of the 67.5°-rotated pattern is as much as about 35% less than for a 0°-rotated pattern sliced vertically. In contrast, using a slicing direction is perpendicular to the 67.5° axis of rotation according to some embodiments provides an estimated resistance that is equal to that estimated for a 0°-rotated pattern. Thus, embodiments provide more accurate resistance estimates for patterns having various orientations relative to the other approach.

The regular pattern 300b may be referred to as a rotated pattern. In some embodiments, the regular patterns 300a, 300b are Manhattan patterns that are partitioned from a conductive structure such as the conductive structure 100.

In some embodiments, the modeling or estimation of the resistance of the pattern includes determining an angle of the pattern, i.e., an angle of the axis of rotation. In some embodiments, the angle of the pattern is determined relative to a central axis of the pattern, which extends through a centerline of pattern.

In some embodiments, a slicing direction SD (whereby the pattern is sliced into one or more polygons) is perpendicular to the axis of rotation. For example, in FIG. 3A-1, the slicing direction SD of the regular pattern 300a is perpendicular to the X axis (and thus parallel to the Y-axis) because the axis of rotation of the regular pattern 300a is 0°. As another example, in FIG. 3A-2, the slicing direction SD of the regular pattern 300b is perpendicular to the 67.5° axis of rotation of the regular pattern 300b, i.e., the slicing direction of the regular pattern 300b is −22.5°.

In some embodiments, slicing the regular patterns 300a and 300b proceeds from a first midpoint MP1 at a first end of the pattern to a second midpoint MP2 at a second end of the pattern. In FIGS. 3A-1 and 3A-2, the midpoints MP1, MP2 are determined relative to a width W of the regular patterns 300a, 300b. In some embodiments, the midpoints MP1, MP2 are on the axis of rotation. In some embodiments, the slicing is performed in a regular manner, e.g., from left-to-right starting from the first midpoint MP1, regardless of the angle of the axis of rotation. As discussed below in connection with FIGS. 5A-1 and 5A-2, in some embodiments the number of slices is the same for a same length L of the regular pattern. That is, in some embodiments, the regular pattern 300a and the regular pattern 300b having the same length L are sliced into a same number of polygons.

FIGS. 3B-1 and 3B-2 are examples of slicing an irregular pattern according to some embodiments.

In FIG. 3B-1, an irregular pattern 310a has an axis of rotation that is rotated at an angle of zero degrees (0° of rotation). In FIG. 3B-2, an irregular pattern 310b has an axis of rotation that is rotated at an angle of 67.5°, by way of example. Embodiments are not limited to a particular angle of rotation, and are applicable to patterns that are not rotated or have an arbitrary angle of rotation. The irregular patterns 310a, 310b have shapes similar to teardrops. In some embodiments, the irregular patterns 310a, 310b are partitioned from a conductive structure such as the conductive structure 100.

In FIGS. 3B-1 and 3B-2, the slicing direction SD is perpendicular to the axis of rotation. For example, in FIG. 3B-1, the slicing direction SD of the irregular pattern 310a is perpendicular to the X axis (and thus parallel to the Y-axis) because the axis of rotation of the irregular pattern 310a is 0°. As another example, in FIG. 3B-2, the slicing direction SD of the irregular pattern 310b is perpendicular to the 67.5° axis of rotation of the irregular pattern 310b, i.e., the slicing direction of the irregular pattern 310b is −22.5°.

In some embodiments, slicing the irregular patterns 310a and 310b proceeds from a first centerpoint P1 at a center of a first via of the pattern to a second centerpoint P2 at a center of a second via of the pattern. In FIGS. 3B-1 and 3B-2, the centerpoints P1, P2 are determined relative to the width of the irregular patterns 310a, 310b. In some embodiments, the centerpoints P1, P2 are on the axis of rotation. In some embodiments, the slicing is performed in a regular manner, e.g., from left-to-right starting from the first centerpoint P1, regardless of the angle of the axis of rotation. As discussed below in connection with FIGS. 5A-1 and 5A-2, in some embodiments the number of slices is the same for a same length L of the irregular pattern. That is, in some embodiments, the irregular pattern 310a and the irregular pattern 310b having the same length L are sliced into a same number of polygons.

Referring again to operations 230, 242, and 244, in the method 200A the conductive structure is partitioned into regular and irregular patterns, and the patterns are sliced into polygons using slices that are perpendicular to the axis of rotation of the respective patterns. In another approach, patterns are all sliced in a same direction (e.g., the patterns are all sliced vertically or perpendicular to the X axis, or the patterns are all sliced horizontally or perpendicular to the Y axis) irrespective of the angle of rotation, resulting in discrepancies in estimated resistance values of e.g., about 30% to 70% or more for a same pattern having different angles of rotation. On the other hand, in the method 200A, operations 242 and 244 slice each pattern into polygons according to the angle of the axis of rotation of the respective pattern, resulting in estimated resistance values that are identical or nearly identical for patterns that are the same except for their axis of rotation. The same applies for the method 200B, i.e., in the method 200B, the conductive structure identified as having a first via is partitioned and the patterns are sliced into polygons by slices that are perpendicular to the axis of rotation of the respective pattern.

Stated another way, in some embodiments, the regular patterns 300a, 300b are sliced into polygons using slices that are perpendicular to the axis of rotation of the respective regular patterns 300a, 300b, and the resulting estimated resistance values for the regular patterns 300a, 300b are identical or nearly identical. Similarly, in some embodiments, the irregular patterns 310a, 310b are sliced into polygons using slices that are perpendicular to the axis of rotation of the respective irregular patterns 310a, 310b, and the resulting estimated resistance values for the irregular patterns 310a, 310b are identical or nearly identical. In some embodiments, estimated resistance values, obtained by slicing patterns into polygons using slices that are perpendicular to the axis of rotation of the respective patterns, match to pico-ohm values or better regardless of the axis of rotation of the pattern and regardless of whether the pattern is a regular pattern or an irregular pattern.

FIG. 3C is an example of slicing directions in partitioning a conductive structure 350 according to some embodiments. In some embodiments, the conductive structure 350 is a portion of the conductive structure 100 described above, e.g., the fifth conductive portion 113.

The conductive structure 350 includes an irregular pattern region 350a having an axis of rotation of first angle A1 is that is 0°, by way of example. The conductive structure 350 also includes, at an opposite end thereof, an irregular pattern region 350b having an axis of rotation of second angle A2 is that is non-zero. The conductive structure 350 also includes, between the irregular pattern regions 350a, 350b, a series of connected regular patterns, collectively identified as region 350c, having various angles of rotation including the first angle A1, a third angle A3 (non-zero), the first angle A1, and the second angle A2, in sequence from left to right. The conductive structure 350 is partitioned according to regular/irregular patterns and according to axis of rotation (thus being partitioned into six patterns, four of which are regular and two of which are irregular), and sliced into polygons using slices that are perpendicular to the axis of rotation of the respective patterns. The resistance value estimated for the conductive structure 350 by summing the resistance values of the polygons thereby obtained is identical, e.g., to pico-ohm values or better, to the theoretical resistance of the conductive structure 350. In another approach in which the entire conductive structure is sliced vertically, i.e., without regard for the axis of rotation of any portions of the structure, an estimated resistance value deviates from the theoretical by about 9%.

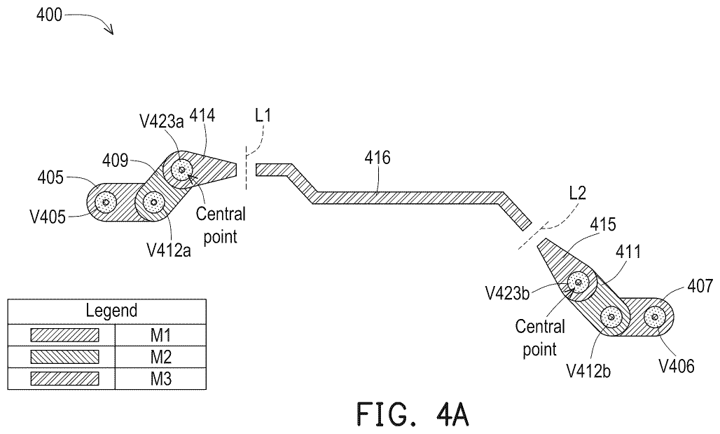

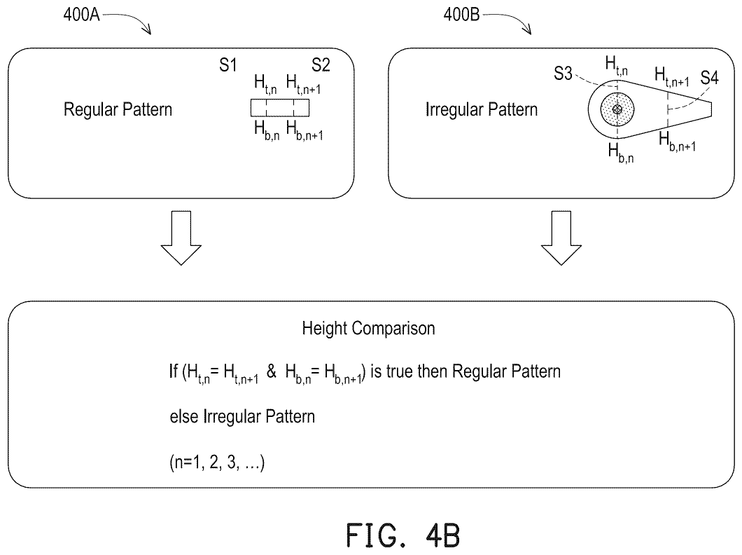

FIGS. 4A and 4B are examples of partitioning a conductive structure 400 according to some embodiments.

In FIG. 4A, a conductive structure 400 is an example of the conductive structure 100 discussed above. Conductive patterns 414, 415, and 416, collectively, are an example of the fifth conductive portion 113 of the conductive structure 100. The conductive portion 416 of the conductive structure 400 is also an example of the region 350c of the conductive structure 350 having a series of connected regular patterns.

Elements of the conductive structure 400 that are similar to elements of the conductive structure 100 have a corresponding identifying numeral, increased by 300.

In FIG. 4A, the conductive structure 400 is partitioned at a first line L1 and a second line L2. In some embodiments, partitioning the conductive structure 400 includes an operation of analyzing the conductive structure 400 to identify regular patterns therein. In the example of FIG. 4A, the analysis has identified regular patterns in the conductive portion 416 and the conductive portion 416 is partitioned from irregular patterns at both ends thereof.

FIG. 4B is an example of operations for identifying regular patterns, e.g., Manhattan patterns, and irregular patterns in a conductive structure such as the conductive structure 400. The operations in FIG. 4B include performing a height comparison on sections of the conductive structure to identify sections having a uniform height. In some embodiments, uniform-height sections are set as being included in a regular pattern or patterns.

In some embodiments, portions of the conductive structure that are not included in a regular pattern or patterns are set as being included in an irregular pattern. In an example of this approach, regular patterns are identified by performing a height comparison on sections of the conductive structure to identify sections having a uniform height, the regular patterns are partitioned from remaining portions of the conductive structure, and the remaining portions are set as being irregular patterns. This approach is described in further detail below in connection with an if-then operation.

In some embodiments, portions of the conductive structure that do not have a uniform height are set as being included in an irregular pattern. In an example of this approach, irregular patterns are identified by performing a height comparison on sections of the conductive structure to identify sections having a non-uniform heights.

In some embodiments, portions of the conductive structure that include a via are set as being included in an irregular pattern. In an example of this approach, irregular patterns are identified by identifying vias, e.g., by identifying circular features in an IC device design. In some embodiments, a via is determined with reference to pins, e.g., input or output pins, in an IC design or layout.

Referring to FIG. 4B, in some embodiments a conductive structure such as the conductive structure 400 is analyzed for the presence of regions having a same height. In the case of a regular pattern 400A of FIG. 4B, the conductive structure is analyzed by performing a height comparison along a first section S1 and a second section S2. The first section S1 has a height determined by a first point H_{t,n} (at top of the section) and a second point H_{b,n} (at bottom of the section). The second section S2 has a height determined by a first point H_{t,n+1} (at top of the section) and a second point H_{b,n+1} (at bottom of the section). In some embodiments, if H_{t,n}=H_{t,n+1} is true and H_{b,n}=H_{b,n+1} is true, the portion of the conductive structure 400 including the first section S1 and the second section S2 is set as a regular pattern. In the case of an irregular pattern 400B of FIG. 4B, a third section S3 has a height determined by a first point H_{t,n} and a second point H_{b,n}, a fourth section S4 has a height determined by a first point H_{t,n+1} and a second point H_{b,n+1}, and H_{t,n}=H_{t,n+1} is false and H_{b,n}=H_{b,n+1} is false, such that the third section S3 and the fourth section S4 are not included in a regular pattern. In some embodiments, the irregular patterns are determined using the if-then operation that has just been described, wherein patterns that are not regular patterns are set as irregular patterns. In some other embodiments, the irregular patterns are determined directly as patterns having sections of non-uniform height and/or including one or more vias.

FIGS. 5A-1, 5A-2, and 5A-3 are examples of resistance estimation of irregular patterns according to some embodiments.

In FIGS. 5A-1 and 5A-2, irregular patterns of a conductive structure, e.g., the conductive structure 100 or the conductive structure 400, are sliced into polygons. Irregular patterns 414 and 415 of the conductive structure 400 are used as examples.

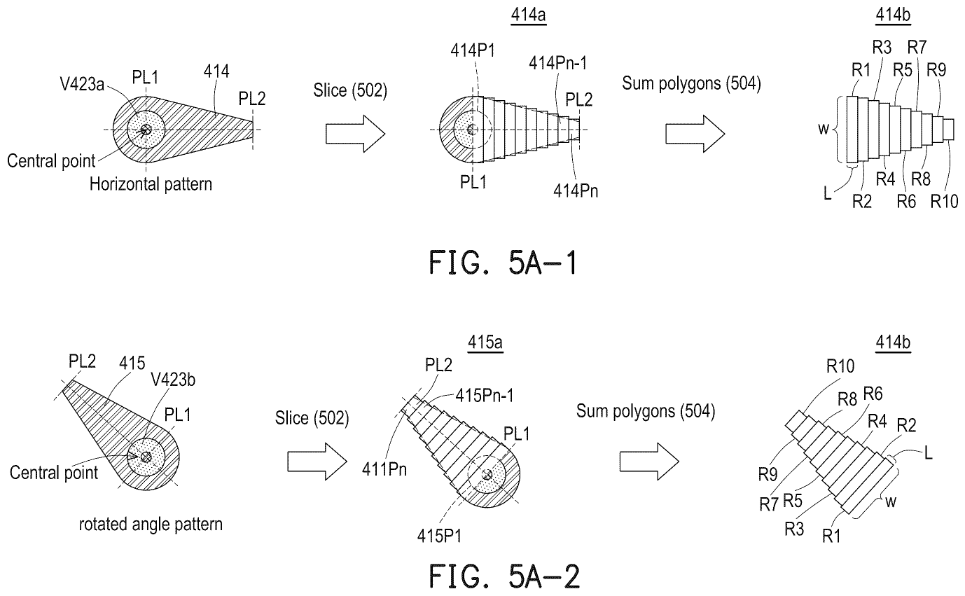

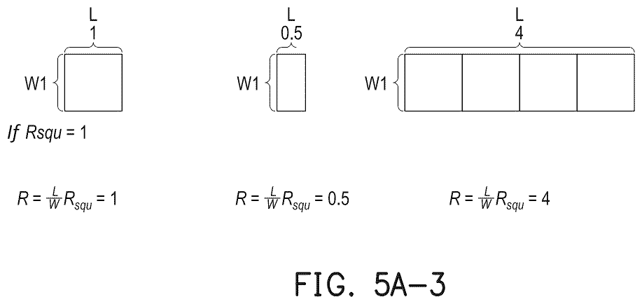

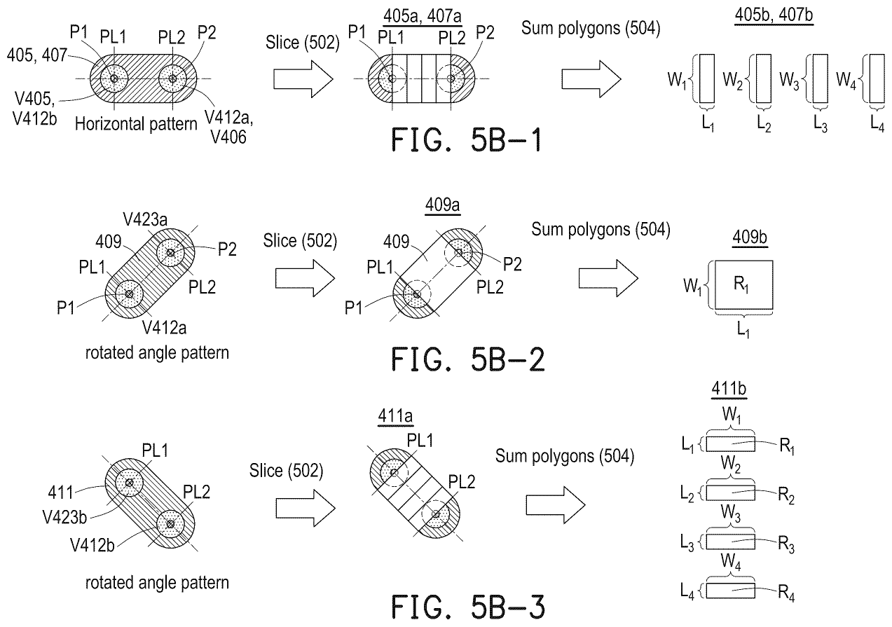

In particular, FIG. 5A-1 is an example of slicing irregular pattern 414 having an axis of rotation that is unrotated or rotated at an angle of zero degrees (0° of rotation, or horizontal), and FIG. 5A-2 is an example of slicing irregular pattern 415 having an axis of rotation that is rotated at a non-zero angle (which is also referred to as a rotated angle pattern).

In FIGS. 5A-1 and 5A-2, examples will be described in which the irregular pattern 414 is identical to the irregular pattern 415 except for the angle of the axis of rotation. Thus, in the examples in FIGS. 5A-1 and 5A-2, the irregular pattern 414 has a same length and same width as the irregular pattern 415.

In FIG. 5A-1 a slicing operation 502 divides the irregular pattern 414 into polygons using slices that are vertical, i.e., perpendicular to the 0°-rotated or horizontal axis of rotation. In FIG. 5A-2, the slicing operation 502 divides the irregular pattern 415 into polygons using slices that are perpendicular to the rotated angle of the axis of rotation. Note that planes PL1 and PL2 are parallel to the slicing direction.

In FIGS. 5A-1 and 5A-2, a number ‘n’ of polygons is the same for the irregular pattern 414 and the irregular pattern 415. In some embodiments, the number ‘n’ of polygons is the same for a same-sized pattern regardless of the angle of the axis of rotation (merely by way of example, sliced pattern 414a has 10 polygons in FIG. 5A-1, and sliced pattern 415a has 10 polygons in FIG. 5A-2; the number ‘n’ is from 1 to 9 or more than 10 in other examples). In some other embodiments, a number ‘n’ of polygons into which a pattern is sliced is changed for patterns having differently-angled axes of rotation. Reducing the number ‘n’ of polygons into which a pattern is divided reduces computational demands and reduces a time consumed in generating resistance estimates in some embodiments. On the other hand, increasing the number of polygons into which the pattern is divided increases the accuracy of a resistance estimation in some embodiments.

FIGS. 5A-1 and 5A-2 are examples in which slicing yields an integer number of polygons between a first plane PL1 and a second plane PL2, i.e., lengths ‘L’ of the polygons (as determined along the axis of rotation) are uniform. In some embodiments, the length ‘L’ of the polygons is determined according to a minimum length value of a model parameter, e.g., a Raphael table or other RC estimation or determination process. In some embodiments, the model parameter provides a relationship between R (ohm) and conductor width and/or length. In some embodiments, the model parameter provides a relationship between R (ohm), conductor material resistivity, and conductor width and/or length.

In some embodiments, polygons such as rectangles, squares, trapezoids, parallelograms, or the like are used to approximate a pattern shape. In some embodiments, the width of polygon along the pattern's axis of rotation is based on the minimum width for the corresponding layer in the model or Raphael table (δ). In some embodiments, a final polygon formed by the slicing would have a width along the pattern's axis of rotation that is smaller than the minimum width for the corresponding layer in the model or Raphael table (δ′), in which case the area of the pattern represented by the final polygon portion of the partition that is smaller than the minimum width is added to the area of the previous polygon (δ+δ′). A detailed example will now be provided.

In some embodiments, the slicing operation 502 divides the pattern into polygons having a minimum length ‘L’ but the pattern does not divide into an integer number of identical-length polygons, in which case a remainder of the pattern that is less than the minimum length ‘L’ is added to an adjacent polygon. For example, in FIG. 5A-1, if a distance between the first plane PL1 and the second plane PL2 were a non-integer multiple of the minimum length ‘L’, then polygons 414P1 through 414Pn−1 would have the minimum length ‘L’ but the polygon 414Pn would have a length (along the axis of rotation) that is less than ‘L’. In this case, the polygon 414Pn−1 is extended to the second plane PL2 to have a length larger than ‘L’, and there would be no polygon P414Pn due to such a polygon being below the minimum length ‘L’ of the model parameter.

In some embodiments, the slicing operation 502 divides the patterns into polygons that all have a length ‘L’ along the axis of rotation that is greater than the minimum length in a model parameter, thus reducing the number of polygons into which the pattern is divided. Reducing the number ‘n’ of polygons into which a pattern is divided reduces computational demands and reduces a time consumed in generating resistance estimates in some embodiments. On the other hand, increasing the number of polygons into which the pattern is divided increases the accuracy of a resistance estimation in some embodiments.

In FIGS. 5A-1 and 5A-2, widths ‘W’ of the polygons vary according to variations in the width of the irregular patterns 414, 415, the width ‘W’ being determined perpendicular to the axis of rotation. The width ‘W’ corresponds to a dimension of the pattern along the slicing direction (perpendicular to the axis of rotation) at the section where the pattern is sliced. In some embodiments, the polygons are squares or rectangles, and the width ‘W’ is the same on the slicing sides of the polygons. In some other embodiments, the polygons are, e.g., trapezoids, and the width ‘W’ on one slicing side of the polygon is different relative to the opposite slicing side of the polygon.

In some embodiments, the slicing operation 502 excludes those portions of the irregular patterns 414, 415 that extend from a central point of the corresponding vias V423a, V423b away from the remainder of the conductive structure 400. Stated another way, in some embodiments, the slicing operation 502 includes only the portions of the irregular patterns 414, 415 that are between a first plane PL1 and a second plane PL2. In some embodiments, the estimated resistance of the conductive structure 400 is considered to be substantially unaffected by those portions of the irregular patterns 414, 415 that are on the outermost ends of the conductive structure 400 beyond the first planes PL1, i.e., beyond the centerpoint of the via. In some embodiments, a portion of a pattern that is not sliced is not included in the resistance estimation of the pattern.

In some embodiments, slicing generates rectangular polygons. In some embodiments, a pattern is sliced into polygons each having a same length, the length being determined in a direction parallel to the axis of the pattern. In some embodiments, an irregularly-shaped pattern is sliced into rectangular polygons having a same length but having widths (which are determined in a direction perpendicular to the axis of the pattern) that can vary. For example, in some embodiments a pattern that tapers (narrows) monotonically from a first end to a second end along its axis is sliced into polygons with constant lengths and progressively shorter widths from the first end to the second end.

Once the polygons 414P1 through 414Pn have been generated, the resistance of the irregular pattern 414 is represented by a polygon group 414b. Similarly, once the polygons 415P1 through 415Pn have been generated, the resistance of the irregular pattern 415 is represented by a polygon group 415b. Individual resistances of the polygons are summed in operation 504 to provide a resistance of the pattern.

In some embodiments, the resistance of the polygon group 414b (which represents the irregular pattern 414 in the third conductive layer M3) and the resistance of the polygon group 415b (which represents the resistance of the irregular pattern 415 in the third conductive layer M3), each polygon group having 10 polygons by way of example, are respectively calculated according to the following:

$${R}_{total} = {\sum }_{n = 1}^{10} {R}_{n} \qquad Eq . 1$$

wherein ‘n’ corresponds to the number of polygons into which the pattern is sliced, i.e., the number of polygons in the polygon group 414b and/or 415b.

In some embodiments, the estimation of the pattern resistance of the polygon group is made based on summing sheet resistance values. In some embodiments, the estimation of the pattern resistance of the polygon group 414b and the pattern resistance of the polygon group 415b (each having 10 polygons by way of example) each include the following calculation:

$${R}_{total} = {\sum }_{n = 1}^{10} \frac{{L}_{n}}{{W}_{n}} {R}_{squ \_ M 3} \qquad Eq . 2$$

wherein ‘n’ corresponds to the number of polygons into which the pattern is sliced, and wherein R_{squ_M3} is the R unit value obtained from the model parameter, and reflects the resistivity of the material (e.g., a metal) of layer M3 in which the patterns 414, 415 are present.

Another way of stating the above example is

$${R}_{n} = \frac{{L}_{n}}{{W}_{n}} {R}_{squ \_ M 3} for n = 1 to 10.$$

Examples of calculating R values based on the R unit value are shown in FIG. 5A-3.

FIGS. 5B-1, 5B-2, and 5B-3 are examples of resistance estimation of patterns according to some embodiments.

In FIGS. 5B-1, 5B-2, and 5B-3, patterns of a conductive structure, e.g., the conductive structure 100 or the conductive structure 400, are sliced into polygons.

In particular, FIG. 5B-1 is an example of slicing patterns 405, 407 having an axis of rotation that is rotated at an angle of zero degrees (0° of rotation, or horizontal), FIG. 5B-2 is an example of slicing pattern 409 having an axis of rotation that is rotated at a non-zero angle, and FIG. 5B-3 is an example of slicing pattern 411 having an axis that is rotated at a non-zero angle different from that of the pattern 409. Also, FIGS. 5B-1, 5B-2, and 5B-3 provide various examples of various numbers of polygons into which the patterns are sliced according to various embodiments.

In FIG. 5B-1 a slicing operation 502 divides the pattern 405 (or 407) into polygons using slices that are vertical, i.e., perpendicular to the 0°-rotated or horizontal axis of rotation. In FIGS. 5B-2 and 5B-3, the slicing operation 502 divides the patterns 409 and 411 into polygons using slices that are perpendicular to the rotated (non-zero) angle of the axis of rotation.

In FIG. 5B-1, the number ‘n’ of polygons is four by way of example. In some embodiments, pattern 405 is sliced into a same number of polygons as pattern 407. In some other embodiments, pattern 405 is sliced into a different number of polygons relative to pattern 407. In FIG. 5B-2, the number ‘n’ of polygons is one by way of example, whereas in FIG. 5B-3 the number ‘n’ of polygons is four by way of example. In some other embodiments, pattern 409 is sliced into a same number ‘n’ of polygons as pattern 411. Reducing the number ‘n’ of polygons into which a pattern is divided reduces computational demands and reduces a time consumed in generating resistance estimates in some embodiments. On the other hand, increasing the number of polygons into which the pattern is divided increases the accuracy of a resistance estimation in some embodiments.

In FIGS. 5B-1, 5B-2, and 5B-3, as with FIGS. 5A-1 and 5A-2, lengths ‘L’ of the polygons (as determined along the axis of rotation) are uniform. In some embodiments the length ‘L’ of the polygons is determined according to a minimum length (or width) value of a model parameter, e.g., a Raphael table or other RC estimation or determination process. In some embodiments, the model parameter provides a relationship between R (ohm) and conductor width and/or length. In some embodiments, the model parameter provides a relationship between R (ohm), conductor material resistivity, and conductor width and/or length. For cases in which a pattern length is such that the slicing operation 502 divides the pattern into polygons having a minimum length ‘L’ but the pattern does not divide into an integer number of identical-length polygons, a remainder of the pattern that is less than the minimum length ‘L’ is added to an adjacent polygon in some embodiments.

In some embodiments, the slicing operation 502 excludes those portions of the patterns 405, 407, 409, and/or 411 that are not between centerpoints of the corresponding vias, i.e., in some embodiments, the slicing operation 502 includes only the portions of the patterns 405, 407, 409, and/or 411 that are between a first plane PL1 and a second plane PL2. In some embodiments, the estimated resistance of the conductive structure 400 is considered to be substantially unaffected by those portions of the patterns 405, 407, 409, and/or 411 that are outside of the region bounded by the first and second planes PL1, PL2.

Once the polygons have been generated, the resistance of the patterns 405, 407, 409, 411 is represented by respective polygon groups 405b, 407b, 409b, 411b. Individual resistances of the polygons are summed in operation 504 to provide a resistance of each pattern, e.g., using calculations analogous to those described above in connections with equations Eq. 1 and Eq. 2, and explained in further detail below.

In some embodiments, the resistance of the polygon groups 405b, 407b (which represent the patterns 405, 407 in the first conductive layer M1), each polygon group having 4 polygons by way of example, are respectively calculated according to the following:

$${R}_{total} = {\sum }_{n = 1}^{4} {R}_{n} \qquad Eq . 3$$

wherein ‘n’ corresponds to the number of polygons into which the pattern is sliced, i.e., the number of polygons in the polygon group 405b and/or 407b.

In some embodiments, the estimation of the pattern resistance of the polygon groups 405b, 407b (each having 4 polygons by way of example) each include the following calculation:

$${R}_{n} = {\sum }_{n = 1}^{4} \frac{{L}_{n}}{{W}_{n}} {R}_{squ \_ M 1} \qquad Eq . 4$$

wherein ‘n’ corresponds to the number of polygons into which the pattern is sliced, and wherein R_{squ_M1} is the R unit value obtained from the model parameter, and reflects the resistivity of the material (e.g., a metal) of layer M1 in which the patterns 405, 407 are present.

In some embodiments, the resistance of the polygon group 409b (which represents the pattern 409 in the second conductive layer M2), the polygon group having 1 polygon by way of example, is calculated according to the following:

$${R}_{total} = {\sum }_{n = 1}^{1} {R}_{n} \qquad Eq . 5$$

wherein ‘n’ corresponds to the number of polygons into which the pattern is sliced, i.e., the number of polygons in the polygon group 409b.

In some embodiments, the estimation of the pattern resistance of the polygon group 409b (having 1 polygon by way of example) includes the following calculation:

$${R}_{n} = {\sum }_{n = 1}^{1} \frac{{L}_{n}}{{W}_{n}} {R}_{squ \_ M 2} \qquad Eq . 6$$

wherein ‘n’ corresponds to the number of polygons into which the pattern is sliced, and wherein R_{squ_M2} is the R unit value obtained from the model parameter, and reflects the resistivity of the material (e.g., a metal) of layer M2 in which the pattern 409 is present.

In some embodiments, the resistance of the polygon group 411b (which represents the pattern 411 in the second conductive layer M2), the polygon group having 4 polygons by way of example, is calculated according to the following:

$${R}_{total} = {\sum }_{n = 1}^{4} {R}_{n} \qquad Eq . 7$$

wherein ‘n’ corresponds to the number of polygons into which the pattern is sliced, i.e., the number of polygons in the polygon group 411b.

In some embodiments, the estimation of the pattern resistance of the polygon group 411b (having 4 polygons by way of example) includes the following calculation:

$${R}_{n} = {\sum }_{n = 1}^{4} \frac{{L}_{n}}{{W}_{n}} {R}_{squ \_ M 2} \qquad Eq . 8$$

wherein ‘n’ corresponds to the number of polygons into which the pattern is sliced, and wherein R_{squ_M2} is the R unit value obtained from the model parameter, and reflects the resistivity of the material (e.g., a metal) of layer M2 in which the pattern 411 is present.

In the examples described above in connection with FIGS. 5A-1, 5A-2, 5B-1, 5B-2, and 5B-3, resistance estimations are made layer-wise, i.e., the conductive structure 400 is partitioned not only by regular patterns/irregular patterns, but also by layer. This approach allows for the pattern resistance to be accurately estimated for each layer by applying the corresponding R unit value obtained from the model parameter for each layer (e.g., R_{squ_M1}, R_{squ_M2}, and R_{squ_M3} described above for conductive layers M1, M2, and M3, respectively).

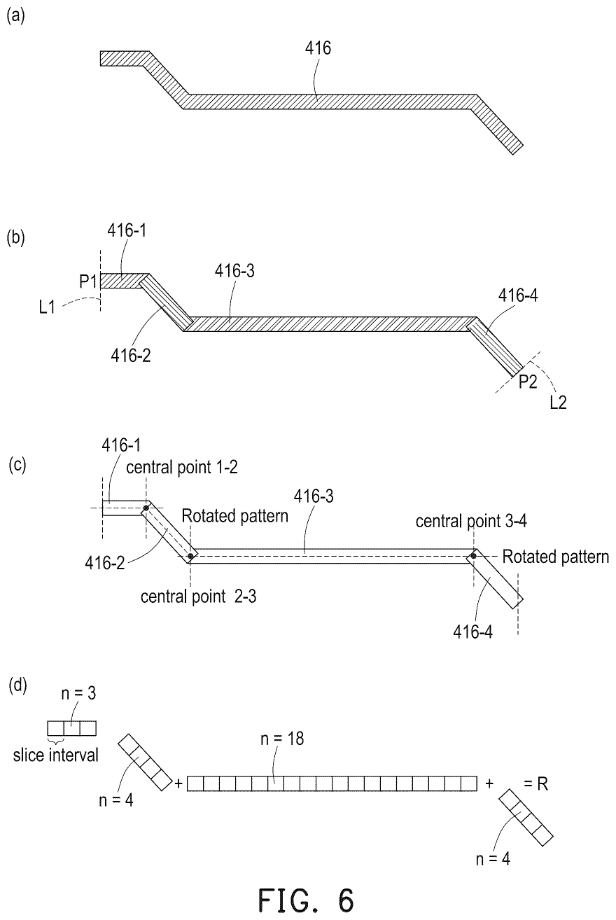

FIG. 6 is an example of resistance estimation of a Manhattan pattern according to some embodiments.

At (a) in FIG. 6, the conductive portion 416 of the conductive structure 400 is an example of a Manhattan pattern. The conductive portion 416 is an interconnection or part of an interconnection in some embodiments.

At (b) in FIG. 6, the conductive portion 416 is shown as including four regular patterns. In some embodiments, identifying the regular patterns is performed as described above in connection with FIG. 4B, e.g., based on a height comparison of sections of the conductive portion 416. In FIG. 6, the regular patterns are identified moving from left to right, i.e., from first line L1 to second line L2. In some other embodiments, the regular patterns are identified from right to left, or in another order. In FIG. 6, the four regular patterns are denoted 416-1, 416-2, 416-3, and 416-4, respectively, moving from left to right.

At (c) in FIG. 6, further details are provided of partitioning a Manhattan pattern according to some embodiments. At (c), regular patterns 416-2 and 416-4 are denoted as rotated patterns. For the case that a pattern is rotated, i.e., the angle of the axis of rotation is non-zero, the partition starts from a central point of previous partition (edge) in some embodiments. Thus, regular pattern 416-2, which is a rotated pattern, starts from central point 1-2 of the previous pattern 416-1 (previous meaning earlier in the left-to-right sequence). Similarly, regular pattern 416-4, which is a rotated pattern, starts from central point 3-4 of the previous pattern 416-3.

At (d) in FIG. 6, resistance estimates are made for each of the respective regular patterns 416-1, 416-2, 416-3, and 416-4 in a manner like that described above in connection with FIGS. 5A-1, 5A-2, 5B-1, 5B-2, and 5B-3. Thus, the respective regular patterns 416-1, 416-2, 416-3, 416-4 are each sliced into polygons by slicing in a direction perpendicular to the axis of rotation. In FIG. 6, merely by way of example, pattern 416-1 is sliced into 3 polygons, pattern 416-2 is sliced into 4 polygons, pattern 416-3 is sliced into 18 polygons, and pattern 416-4 is sliced into 4 polygons. In some embodiments, the number of slices in each partition is determined based on a minimum length (or width) value of a model parameter, e.g., a Raphael table or other RC estimation or determination process. In some other embodiments, the pattern is decomposed into a smaller number of polygons than would be obtained using the minimum value of the model parameter. Reducing the number of polygons into which a pattern is divided reduces computational demands and reduces a time consumed in generating resistance estimates in some embodiments. On the other hand, increasing the number of polygons into which the pattern is divided increases the accuracy of a resistance estimation in some embodiments.

Once the polygons have been generated, individual resistances of the polygons are summed in operation 504 to provide a resistance of each of regular patterns 416-1, 416-2, 416-3, 416-4, e.g., using calculations analogous to those described above in connections with equations Eq. 1 and Eq. 2. In FIG. 6, each of the regular patterns 416-1, 416-2, 416-3, 416-4 is in a same conductive layer (M3 in the example of FIG. 6). Thus, the calculation corresponding to the above Eq. 2 uses R_{squ_M3}, which is the R unit value obtained from the model parameter that reflects the resistivity of the material (e.g., a metal) of layer M3 in which the regular patterns 416-1, 416-2, 416-3, 416-4 are present.

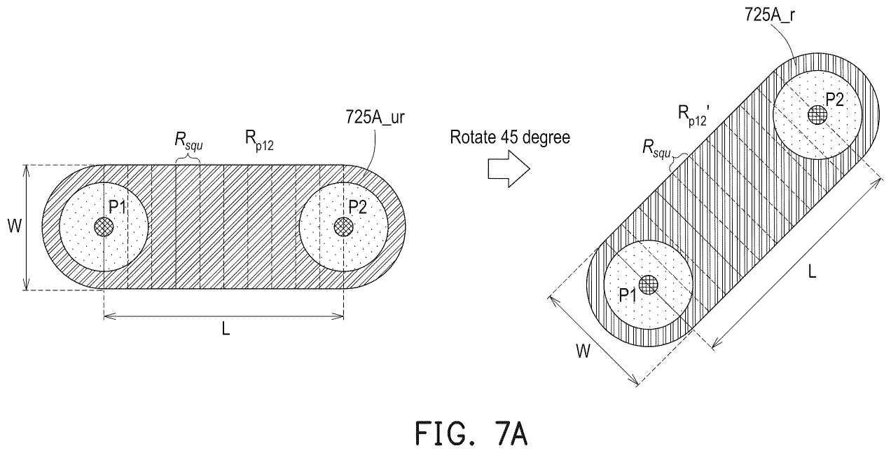

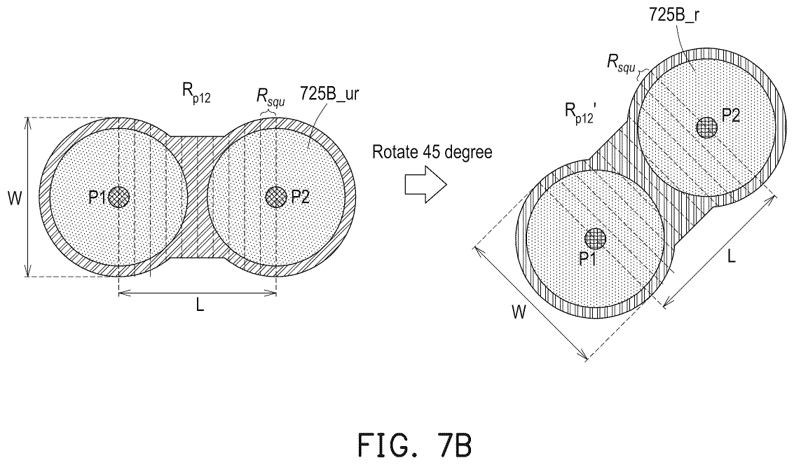

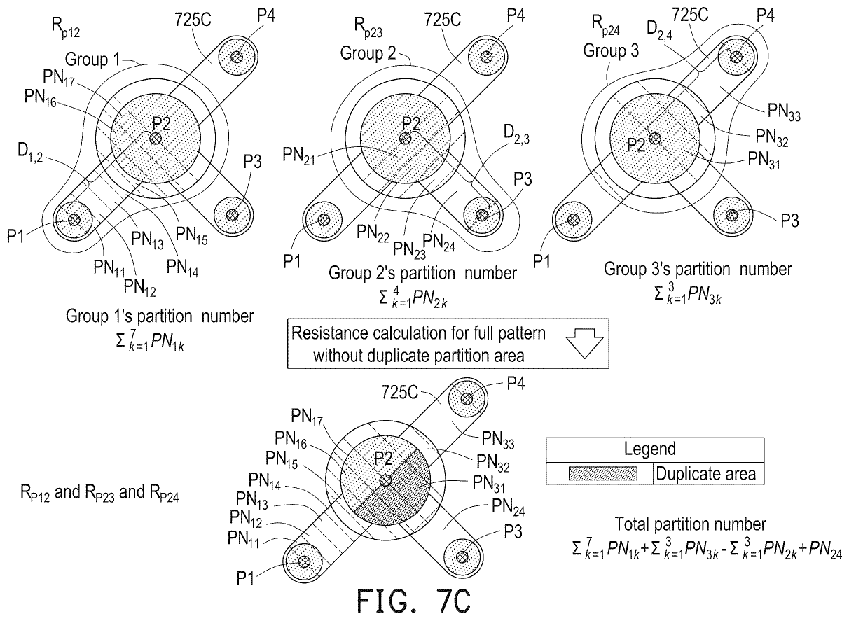

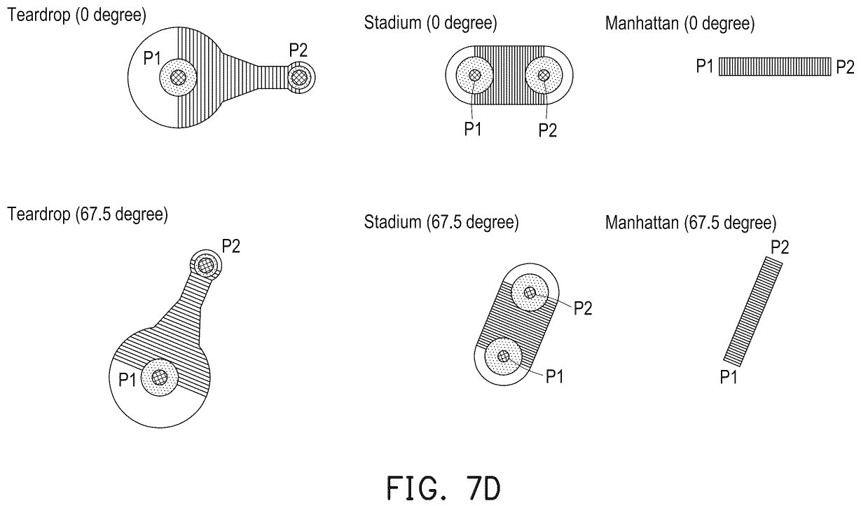

FIGS. 7A and 7B are examples of resistance estimation for unrotated and rotated patterns according to some embodiments.

In FIG. 7A, a track-shaped or stadium-shaped pattern is shown in unrotated and rotated states, i.e., as an unrotated pattern 725A_ur having an axis of rotation that is horizontal (0° angle of rotation), and as a rotated pattern 725A_r having an axis of rotation that is rotated 45°, by way of example. Embodiments are not limited to a particular angle of rotation, and are applicable to patterns that are not rotated or have an arbitrary angle of rotation. For both the unrotated pattern 725A_ur and the rotated pattern 725A_r, a slicing direction is perpendicular to the axis of rotation.

In another approach in which a 45°-rotated pattern is sliced vertically, an estimated resistance of the 45°-rotated pattern is less than for a 0°-rotated pattern sliced vertically. Also, in another approach in which a 45°-rotated pattern is sliced horizontally, an estimated resistance of the 45°-rotated pattern is greater than for a 0°-rotated pattern sliced vertically. In contrast, using a slicing direction is perpendicular to the 45°-rotated axis of rotation according to some embodiments provides an estimated resistance that is equal to that estimated for a 0°-rotated pattern. Thus, embodiments provide more accurate resistance estimates for patterns having various orientations relative to the other approach.

In FIG. 7A, both the unrotated pattern 725A_ur and the rotated pattern 725A_r are sliced from a first centerpoint P1 (which is a first via centerpoint) to a second centerpoint P2 (which is a second via centerpoint). Resistance is thus estimated based on the portion of the pattern between centerpoints P1 and P2. Also, lengths ‘L’ and widths ‘W’ are the same, and the resulting number of polygons is the same.

The estimated resistance Rp12 of the unrotated pattern 725A_ur and the estimated resistance Rp12′ of the rotated pattern 725A_r are identical, e.g., to pico-ohm values or better. On the other hand, in another approach in which the stadium-shaped patterns are all sliced in a same direction (e.g., all sliced vertically or all sliced horizontally) irrespective of the angle of rotation, and the entire pattern is sliced (rather than from via center to via center), discrepancies in estimated resistance values can be 70% or more for a rotated stadium-shaped pattern. Thus, embodiments provide more accurate resistance estimates for patterns having various orientations relative to the other approach.

In FIG. 7B, a dumbbell-shaped pattern is shown in unrotated and rotated states, i.e., as an unrotated pattern 725B_ur having an axis of rotation that is horizontal (0° angle of rotation), and as a rotated pattern 725B_r having an axis of rotation that is rotated 45°, by way of example. Embodiments are not limited to a particular angle of rotation, and are applicable to patterns that are not rotated or have an arbitrary angle of rotation. For both the unrotated pattern 725B_ur and the rotated pattern 725B_r, a slicing direction is perpendicular to the axis of rotation.

In FIG. 7B, both the unrotated pattern 725B_ur and the rotated pattern 725B_r are sliced from a first centerpoint P1 (which is a first via centerpoint) to a second centerpoint P2 (which is a second via centerpoint). Resistance is thus estimated based on the portion of the pattern between centerpoints P1 and P2. Also, lengths ‘L’ and widths ‘W’ are the same, and the resulting number of polygons is the same.

The estimated resistance Rp12 of the unrotated pattern 725B_ur and the estimated resistance Rp12′ of the rotated pattern 725B_r are identical, e.g., to pico-ohm values or better. On the other hand, in another approach in which the dumbbell-shaped patterns are all sliced in a same direction (e.g., all sliced vertically or all sliced horizontally) irrespective of the angle of rotation, and the entire pattern is sliced (rather than from via center to via center), an estimated resistance values for the rotated dumbbell-shaped pattern 725B_r is less than the estimated resistance for the unrotated dumbbell-shaped pattern 725B_ur. Thus, embodiments provide more accurate resistance estimates for patterns having various orientations relative to the other approach.

FIG. 7C is an example of estimating resistance for a complex conductive structure 725C having portions that are rotated at two different non-zero angles.

In some embodiments, estimating resistance of the conductive structure 725C includes counting a number of vias in the conductive structure 725C, grouping partitions, calculating each group's resistance, and calculating all groups' combined resistance.

In the example of FIG. 7C, the via count in the conductive structure 725C is four and centerpoints of the vias are respectively denoted as P1, P2, P3, and P4.

The partitions are grouped into three groups with reference to the via centerpoints. Group 1 includes via centerpoints P1 and P2. Group 2 includes via centerpoints P2 and P3. Group 3 includes via centerpoints P2 and P4.

Merely by way of example, the number of polygons in Group 1 is 7, the number of polygons in Group 2 is 4, and the number of polygons in Group 3 is 3. In further detail, in Group 1 a distance D_{1,2} that separates via centerpoints P1 and P2 is sliced into 7 polygons. In Group 2 a distance D_{2,3} that separates via centerpoints P2 and P3 is sliced into 4 polygons. In Group 3 a distance D_{2,4} that separates via centerpoints P2 and P4 is sliced into 3 polygons. The numbers of polygons are different in some other embodiments.

The resistance R_{P12} of Group 1 corresponds to Group 1's partition number, which is represented by

$${\sum }_{k = 1}^{7} P {N}_{1 k} .$$

The resistance K_{P23} Or Group 2 corresponds to Group 2's partition number, which is represented by

$${\sum }_{k = 1}^{4} P {N}_{2 k} .$$

The resistance K_{P23} of Group 3 corresponds to Group 3's partition number, which is represented by

$${\sum }_{k = 1}^{3} P {N}_{3 k} .$$

If simply added together, the summed respective group resistances R_{P12}, R_{P23}, and R_{P23} would not accurately estimate the resistance of the conductive structure 725C due to duplicated area. Thus, summed resistance R_{P12}+R_{P23}+R_{P24} of the conductive structure 725C corresponds to a total partition number represented by

$${\sum }_{k = 1}^{7} P {N}_{1 k} + {\sum }_{k = 1}^{3} P {N}_{3 k} - {\sum }_{k = 1}^{3} P {N}_{2 k} + P {N}_{24} ,$$

which accounts for the duplicate area.

As described above in connection with FIG. 7C, in some embodiments a complex conductive structure having a plurality of vias is analyzed to estimate the resistance of the conductive structure using an approach that separates the conductive structure into groups while accounting for duplicate areas shared by the groups. In some embodiments, a complex conductive structure includes a plurality of vias and forms a loop or a short circuit, and the resistance estimating process includes separating the structure into portions or groups having no loop or short circuit.

FIG. 7D is an example of estimating resistance for teardrop, stadium, and Manhattan-shaped patterns.

FIG. 7D includes examples of teardrop, stadium, and Manhattan-shaped patterns, each including an unrotated pattern (0° angle of axis of rotation) and rotated pattern (45° angle of axis of rotation). The 45° angle of rotation is merely an example. Embodiments are not limited to a particular angle of rotation, and are applicable to patterns that are not rotated or have an arbitrary angle of rotation. In the teardrop and stadium-shaped patterns, a slicing region extends between via centerpoints P1 and P2. For each of the six examples in FIG. 7D, a slicing direction used to generate polygons for estimating the pattern resistance is perpendicular to the axis of rotation. The estimated resistance of the unrotated teardrop-shaped pattern and the estimated resistance of the rotated teardrop-shaped pattern are identical, e.g., to pico-ohm values or better. The estimated resistance of the unrotated stadium-shaped pattern and the estimated resistance of the rotated stadium-shaped pattern are identical, e.g., to pico-ohm values or better. The estimated resistance of the unrotated Manhattan-shaped pattern and the estimated resistance of the rotated Manhattan-shaped pattern are identical, e.g., to pico-ohm values or better.

On the other hand, in another approach in which the teardrop-shaped patterns are both sliced in a same direction (e.g., all sliced vertically or all sliced horizontally) irrespective of the angle of rotation, and the entire teardrop-shaped pattern is sliced (rather than from via center to via center), an estimated resistance values for the rotated teardrop-shaped pattern is less than the estimated resistance for the unrotated teardrop-shaped pattern by about 30%. Further, the estimated resistance for the unrotated teardrop-shaped pattern is itself less than a theoretical resistance by about 5%.

Also, in another approach in which the stadium-shaped patterns are both sliced in a same direction (e.g., all sliced vertically or all sliced horizontally) irrespective of the angle of rotation, and the entire stadium-shaped pattern is sliced (rather than from via center to via center), an estimated resistance values for the rotated stadium-shaped pattern is less than the estimated resistance for the unrotated stadium-shaped pattern by about 75%. Further, the estimated resistance for the unrotated stadium-shaped pattern is itself somewhat less than a theoretical resistance.

Also, in another approach in which the Manhattan-shaped patterns are both sliced in a same direction (e.g., all sliced vertically or all sliced horizontally) irrespective of the angle of rotation, an estimated resistance values for the rotated Manhattan-shaped pattern is less than the estimated resistance for the Manhattan-shaped pattern by about 55%. Further, the estimated resistance for the unrotated Manhattan-shaped pattern is itself somewhat less than a theoretical resistance.

Thus, embodiments provide more accurate resistance estimates for patterns such as the teardrop, stadium, and Manhattan-shaped patterns of FIG. 7D having various orientations, relative to the other approach.

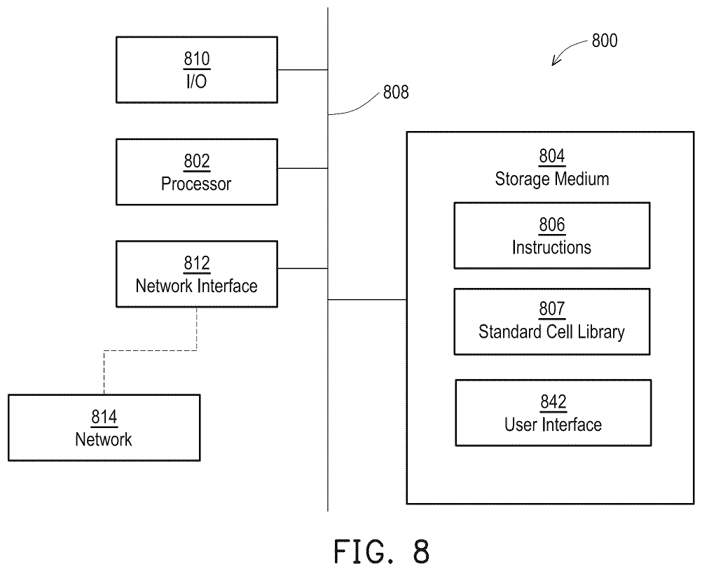

FIG. 8 is a block diagram of an electronic design automation (EDA) system 800 according to some embodiments.

In some embodiments, EDA system 800 includes an Automatic Place & Route (APR) system. Methods of designing layouts representing wire routing arrangements of semiconductor devices in accordance with one or more embodiments are implementable, for example, using EDA system 800, according to some embodiments.

In some embodiments, EDA system 800 is a general-purpose computing device including a hardware processor 802 and a non-transitory, computer-readable storage medium 804. The computer-readable storage medium 804, amongst other things, is encoded with, i.e., stores, computer program code 806, i.e., a set of executable instructions. Execution of instructions 806 by the processor 802 represents (at least in part) an EDA tool that implements a portion or all of processes and/or methods for, e.g., synthesis, placement, and routing of a region that includes a ROM, e.g., corresponding one or more of the ROM semiconductor devices described above and/or represented in Table 1, in accordance with one or more embodiments (hereinafter, the noted processes and/or methods).

The processor 802 is electrically coupled to the computer-readable storage medium 804 by a bus 808. The processor 802 is also electrically coupled to an I/O interface 810 by the bus 808. A network interface 812 is also electrically connected to processor 802 by the bus 808. Network interface 812 is connected to a network 814, so that the processor 802 and the computer-readable storage medium 804 are capable of connecting to external elements by network 814. Processor 802 is configured to execute computer program code 806 encoded in the computer-readable storage medium 804 in order to cause EDA system 800 to be usable for performing a portion or all of the noted processes and/or methods. In one or more embodiments, processor 802 is a central processing unit (CPU), a multi-processor, a distributed processing system, an application specific integrated circuit (ASIC), and/or a suitable processing unit.

In one or more embodiments, the computer-readable storage medium 804 is an electronic, magnetic, optical, electromagnetic, infrared, and/or a semiconductor system (or apparatus or device). Examples of the computer-readable storage medium 804 include a semiconductor or solid-state memory, a magnetic tape, a removable computer diskette, a random access memory (RAM), a read-only memory (ROM), a rigid magnetic disk, and/or an optical disk. In one or more embodiments using optical disks, the computer-readable storage medium 804 includes a compact disk read-only memory (CD-ROM), a compact disk-read/write (CD-R/W), and/or a digital video disc (DVD).

In one or more embodiments, the computer-readable storage medium 804 stores computer program code 806 configured to cause EDA system 800 (where such execution represents (at least in part) the EDA tool) to be usable for performing a portion or all of the noted processes and/or methods. In one or more embodiments, the computer-readable storage medium 804 also stores information that facilitates performing a portion or all of the noted processes and/or methods. In one or more embodiments, the computer-readable storage medium 804 stores library 807 of standard cells including such standard cells as disclosed herein.

The EDA system 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

The EDA system 800 also includes network interface 812 coupled to processor 802. Network interface 812 allows EDA system 800 to communicate with network 814, to which one or more other computer systems are connected. Network interface 812 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more EDA systems 800.

The EDA system 800 is configured to receive information through I/O interface 810. The information received through I/O interface 810 includes one or more of instructions, data, design rules, libraries of standard cells, and/or other parameters for processing by processor 802. The information is transferred to processor 802 by the bus 808. EDA system 800 is configured to receive information related to a user interface (UI) through I/O interface 810. The information is stored in the computer-readable storage medium 804 as user interface (UI) 842.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 800. In some embodiments, a layout that includes standard cells is generated using a tool such as VIRTUOSO® available from Cadence Design Systems, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

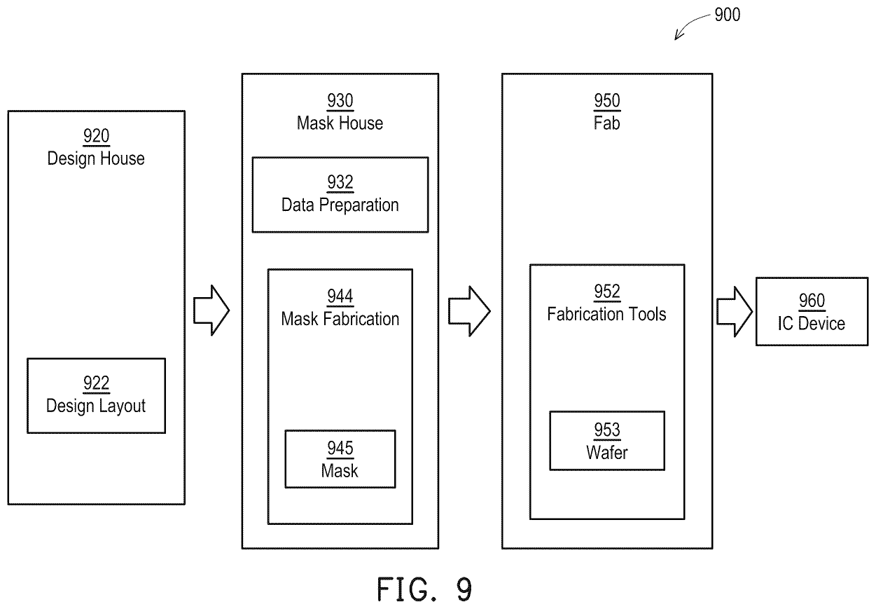

FIG. 9 is a block diagram of an integrated circuit (IC) manufacturing system 900, and an IC manufacturing flow associated therewith, according to some embodiments.

In some embodiments, based on a layout, at least one of (A) one or more semiconductor masks or (B) at least one component in a layer of a semiconductor integrated circuit is fabricated using the IC manufacturing system 900.

In FIG. 9, the IC manufacturing system 900 includes entities, such as a design house 920, a mask house 930, and an IC manufacturer/fabricator (fab) 950, that interact with one another in the design, development, and manufacturing cycles and/or services related to manufacturing an IC device 960, e.g., corresponding to the ROM devices described above with reference to Table 1. The entities in the IC manufacturing system 900 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of the design house 920, the mask house 930, and the IC fab 950 are owned by a single larger company. In some embodiments, two or more of the design house 920, the mask house 930, and the IC fab 950 coexist in a common facility and use common resources.

The design house (or design team) 920 generates an IC design layout 922. The IC design layout 922 includes various geometrical patterns designed for an IC device 960. The geometrical patterns correspond to patterns of metal, oxide, or semiconductor layers that make up the various components of the IC device 960 to be fabricated. The various layers combine to form various IC features. For example, a portion of the IC design layout 922 includes various IC features, such as an active region, gate electrode, source and drain, metal lines or vias of an interlayer interconnect, UTM interconnect structure, or the like, passivation layer structures, openings for bonding pads, and conductive bumps to be formed in a semiconductor substrate (such as a silicon wafer) and various material layers disposed on the semiconductor substrate. The design house 920 implements a formal design procedure to form the IC design layout 922. The design procedure includes one or more of logic design, physical design or place-and-route operation. The IC design layout 922 is presented in one or more data files having information of the geometrical patterns. For example, the IC design layout 922 can be expressed in a GDSII file format or DFII file format.

The mask house 930 includes mask data preparation 932 and mask fabrication 944. The mask house 930 uses the IC design layout 922 to manufacture one or more masks 945 to be used for fabricating the various layers of the IC device 960 according to the IC design layout 922. The mask house 930 performs the mask data preparation 932, where the IC design layout 922 is translated into a representative data file (RDF). The mask data preparation 932 provides the RDF to the mask fabrication 944. The mask fabrication 944 includes a mask writer. The mask writer converts the RDF to an image on a substrate, such as a mask (reticle) 945 or a semiconductor wafer 953. The IC design layout 922 is manipulated by the mask data preparation 932 to comply with particular characteristics of the mask writer and/or requirements of the IC fab 950. In FIG. 9, the mask data preparation 932 and the mask fabrication 944 are illustrated as separate elements. In some embodiments, the mask data preparation 932 and the mask fabrication 944 can be collectively referred to as mask data preparation.

In some embodiments, the mask data preparation 932 includes optical proximity correction (OPC) that uses lithography enhancement techniques to compensate for image errors, such as those that can arise from diffraction, interference, other process effects and the like. The OPC adjusts the IC design layout 922. In some embodiments, the mask data preparation 932 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, the mask data preparation 932 includes a mask rule checker (MRC) that checks the IC design layout 922 that has undergone processes in the OPC with a set of mask creation rules containing geometric and/or connectivity restrictions to ensure sufficient margins, to account for variability in semiconductor manufacturing processes, and the like. In some embodiments, the MRC modifies the IC design layout 922 to compensate for limitations during the mask fabrication 944, which may undo part of the modifications performed by OPC in order to meet mask creation rules.

In some embodiments, the mask data preparation 932 includes lithography process checking (LPC) that simulates processing that will be implemented by the IC fab 950 to fabricate the IC device 960. The LPC simulates this processing based on the IC design layout 922 to create a simulated manufactured device, such as the IC device 960. The processing parameters in LPC simulation can include parameters associated with various processes of the IC manufacturing cycle, parameters associated with tools used for manufacturing the IC, and/or other aspects of the manufacturing process. The LPC takes into account various factors, such as aerial image contrast, depth of focus (DOF), mask error enhancement factor (MEEF), other suitable factors, and the like or combinations thereof. In some embodiments, after a simulated manufactured device has been created by LPC, if the simulated device is not close enough in shape to satisfy design rules, OPC and/or MRC are repeated to further refine the IC design layout 922.

It should be understood that the above description of the mask data preparation 932 has been simplified for the purposes of clarity. In some embodiments, the mask data preparation 932 includes additional features such as a logic operation (LOP) to modify the IC design layout 922 according to manufacturing rules. Additionally, the processes applied to the IC design layout 922 during the mask data preparation 932 may be executed in a variety of different orders.

After the mask data preparation 932 and during the mask fabrication 944, a mask 945 or a group of masks 945 are fabricated based on the modified IC design layout 922. In some embodiments, the mask fabrication 944 includes performing one or more lithographic exposures based on the IC design layout 922. In some embodiments, an electron-beam (e-beam) or a mechanism of multiple e-beams is used to form a pattern on a mask (photomask or reticle) 945 based on the modified IC design layout 922. The mask 945 can be formed in various technologies. In some embodiments, the mask 945 is formed using binary technology. In some embodiments, a mask pattern includes opaque regions and transparent regions. A radiation beam, such as an ultraviolet (UV) beam, used to expose the image sensitive material layer (e.g., photoresist) that has been coated on a wafer, is blocked by the opaque region and transmits through the transparent regions. In one example, a binary mask version of the mask 945 includes a transparent substrate (e.g., fused quartz) and an opaque material (e.g., chromium) coated in the opaque regions of the binary mask. In another example, the mask 945 is formed using a phase shift technology. In a phase shift mask (PSM) version of the mask 945, various features in the pattern formed on the phase shift mask are configured to have proper phase difference to enhance the resolution and imaging quality. In various examples, the phase shift mask can be attenuated PSM or alternating PSM. The mask(s) generated by the mask fabrication 944 is used in a variety of processes. For example, such a mask(s) is used in an ion implantation process to form various doped regions in a semiconductor wafer 953, in an etching process to form various etching regions in the semiconductor wafer 953, and/or in other suitable processes.

The IC fab 950 is an IC fabrication business that includes one or more manufacturing facilities for the fabrication of a variety of different IC products. In some embodiments, the IC fab 950 is a semiconductor foundry. For example, there may be a manufacturing facility for the front end fabrication of a plurality of IC products (front-end-of-line (FEOL) fabrication), while a second manufacturing facility may provide the back end fabrication for the interconnect and packaging of the IC products (back-end-of-line (BEOL) fabrication), and a third manufacturing facility may provide other services for the foundry business.

The IC fab 950 includes fabrication tools 952 configured to execute various manufacturing operations on semiconductor wafer 953 such that the IC device 960 is fabricated in accordance with the mask(s), e.g., the mask 945. In various embodiments, the fabrication tools 952 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

The IC fab 950 uses the mask(s) 945 fabricated by the mask house 930 to fabricate the IC device 960. Thus, the IC fab 950 at least indirectly uses the IC design layout 922 to fabricate the IC device 960. In some embodiments, the semiconductor wafer 953 is fabricated by the IC fab 950 using the mask(s) 945 to form the IC device 960. In some embodiments, the IC fabrication includes performing one or more lithographic exposures based at least indirectly on the IC design layout 922. The semiconductor wafer 953 includes a silicon substrate or other proper substrate having material layers formed thereon. The semiconductor wafer 953 further includes one or more of various doped regions, dielectric features, multilevel interconnects, and the like (formed at subsequent manufacturing steps).

Details regarding an integrated circuit (IC) manufacturing system (e.g., the IC manufacturing system 900 of FIG. 9), and an IC manufacturing flow associated therewith are found, e.g., in U.S. Pat. No. 9,256,709, granted Feb. 9, 2016, U.S. Pre-Grant Publication No. 2015/0278429, published Oct. 1, 2015, U.S. Pre-Grant Publication No. 2014/0040838, published Feb. 6, 2014, and U.S. Pat. No. 7,260,442, granted Aug. 21, 2007, the entireties of each of which are hereby incorporated by reference.

In some embodiments, a method of evaluating resistance in an integrated circuit (IC) device design includes identifying a conductive structure in the IC device design; identifying one or more regular patterns in the conductive structure; partitioning the one or more regular patterns from one or more remaining portions of the conductive structure, the one or more remaining portions being one or more irregular patterns; for the one or more regular patterns and the one or more irregular patterns: determining a rotation angle of the pattern; slicing the pattern, in a direction perpendicular to the rotation angle, into one or more polygons; and summing individual resistances of each of the one or more polygons to provide a resistance of the pattern; summing the resistances of the one or more regular patterns and the one or more irregular patterns to provide an estimated resistance of the conductive structure; and generating a revised IC device design by revising the IC device design using the estimated resistance.

In some embodiments, a method of designing an integrated circuit (IC) device includes identifying a conductive structure in a first IC device design; partitioning the conductive structure into at least a first pattern and a second pattern, the second pattern having a second rotation angle that is different from a first rotation angle of the first pattern; slicing the first pattern, in a first direction perpendicular to the first rotation angle, into one or more first polygons, and summing resistances of the one or more first polygons to provide a first resistance of the first pattern; slicing the second pattern, in a second direction perpendicular to the second rotation angle and different from the first direction, into one or more second polygons, and summing resistances of the one or more second polygons to provide a second resistance of the second pattern; providing an estimated resistance of the conductive structure that includes the resistances of the first and second patterns; and generating a second IC device design by revising the first IC device design, the generating the second IC device design including revising an electrical characteristic of a circuit that includes the conductive structure, based on the estimated resistance of the conductive structure.

In some embodiments, a system includes: at least one processor; and at least one non-transitory computer-readable recording medium that stores computer program code and an integrated circuit (IC) device design, wherein, when the at least one processor executes the computer program code stored in the at least one non-transitory computer-readable recording medium, the computer program code and the at least one processor cause the system to: identify a first via in the IC device design; determine a rotation angle of a first irregular pattern that includes the first via, the rotation angle being non-zero relative to a horizontal axis of the IC device design; slice the first irregular pattern, in a direction perpendicular to the rotation angle, into a plurality of polygons; sum individual resistances of each polygon of the plurality of polygons to provide an estimated resistance of the first irregular pattern; and generate a revised IC device design by revising the IC device design, the generating the revised IC device design including revising an electrical characteristic of a circuit that includes the first irregular pattern, based on the estimated resistance of the first irregular pattern.

It will be appreciated that features, characteristics, and/or elements described in connection with a particular embodiment are usable singly or in combination with features, characteristics, and/or elements described in connection with one or more other embodiments unless otherwise specifically indicated.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of evaluating resistance in an integrated circuit (IC) device design, the method comprising:
identifying a conductive structure in the IC device design;
identifying one or more regular patterns in the conductive structure;
partitioning the one or more regular patterns from one or more remaining portions of the conductive structure, the one or more remaining portions being one or more irregular patterns;
for the one or more regular patterns and the one or more irregular patterns:
determining a rotation angle of the pattern;
slicing the pattern, in a direction perpendicular to the rotation angle, into one or more polygons; and
summing individual resistances of each of the one or more polygons to provide a resistance of the pattern;
summing the resistances of the one or more regular patterns and the one or more irregular patterns to provide an estimated resistance of the conductive structure; and
generating a revised IC device design by revising the IC device design using the estimated resistance.

2. The method of claim 1, wherein:
identifying the conductive structure includes:
identifying a first via in the conductive structure, the first via corresponding to a first irregular pattern.

3. The method of claim 2, further comprising:
identifying a second via in the first irregular pattern;
slicing the first irregular pattern into polygons from a center of the first via to a center of the second via; and
summing individual resistances of the polygons of the first irregular pattern to provide a resistance of the first irregular pattern.

4. The method of claim 1, wherein each of the one or more polygons has two sides that are perpendicular to the rotation angle of the pattern.

5. The method of claim 1, wherein the pattern has a rotation angle that is non-zero relative to a horizontal axis of the IC device design.

6. The method of claim 5, wherein the one or more regular patterns include a Manhattan pattern.

7. The method of claim 1, wherein:
generating the revised IC device design includes:
revising an electrical characteristic of a circuit that includes the conductive structure, using the estimated resistance of the conductive structure.

8. The method of claim 7, wherein:
the electrical characteristic includes one or more of a resistance value, a timing value, or a current value.

9. The method of claim 1, further comprising:
generating a tape-out data file based on the revised IC device design.

10. The method of claim 9, further comprising:
manufacturing an IC device based on the tape-out data file.

11. The method of claim 1, wherein:
identifying the conductive structure includes:
identifying a first via in the conductive structure, the first via corresponding to a first irregular pattern; and
identifying that the first irregular pattern includes the first via and is free of any other vias, and
slicing the pattern into one or more polygons includes:
slicing the first irregular pattern into the one or more polygons starting from a center of the first via and ending at an end of the first irregular pattern.

12. A method of designing an integrated circuit (IC) device, the method comprising:
identifying a conductive structure in a first IC device design;
partitioning the conductive structure into at least a first pattern and a second pattern, the second pattern having a second rotation angle that is different from a first rotation angle of the first pattern;
slicing the first pattern, in a first direction perpendicular to the first rotation angle, into one or more first polygons, and summing resistances of the one or more first polygons to provide a first resistance of the first pattern;
slicing the second pattern, in a second direction perpendicular to the second rotation angle and different from the first direction, into one or more second polygons, and summing resistances of the one or more second polygons to provide a second resistance of the second pattern;
providing an estimated resistance of the conductive structure that includes the resistances of the first and second patterns; and
generating a second IC device design by revising the first IC device design, the generating the second IC device design including revising an electrical characteristic of a circuit that includes the conductive structure, based on the estimated resistance of the conductive structure.

13. The method of claim 12, wherein:
identifying the conductive structure includes:
identifying a first via in the conductive structure, the first via corresponding to a first irregular pattern that is one of the first pattern or the second pattern.

14. The method of claim 13, further comprising:
identifying a second via in the first irregular pattern;
slicing the first irregular pattern into polygons from a center of the first via to a center of the second via; and
summing individual resistances of the polygons of the first irregular pattern to provide a resistance of the first irregular pattern as the resistance of the first pattern or the second pattern.

15. The method of claim 12, wherein each of the one or more first polygons and each of the one or more second polygons has two sides that are perpendicular to the corresponding rotation angle of the pattern.

16. The method of claim 12, wherein:
identifying the conductive structure includes:
identifying a first via in the conductive structure, the first via corresponding to a first irregular pattern that is one of the first pattern or the second pattern,
the method further comprising:
identifying that the first irregular pattern includes the first via and is free of any other vias;
slicing the first irregular pattern into polygons from a center of the first via to an end of the first irregular pattern; and
summing individual resistances of the polygons of the first irregular pattern to provide a resistance of the first irregular pattern as the resistance of the first pattern or the second pattern.

17. A system comprising:
at least one processor; and
at least one non-transitory computer-readable recording medium that stores computer program code and an integrated circuit (IC) device design,
wherein, when the at least one processor executes the computer program code stored in the at least one non-transitory computer-readable recording medium, the computer program code and the at least one processor cause the system to:
identify a first via in the IC device design;
determine a rotation angle of a first irregular pattern that includes the first via, the rotation angle being non-zero relative to a horizontal axis of the IC device design;
slice the first irregular pattern, in a direction perpendicular to the rotation angle, into a plurality of polygons;
sum individual resistances of each polygon of the plurality of polygons to provide an estimated resistance of the first irregular pattern; and
generate a revised IC device design by revising the IC device design, the generating the revised IC device design including revising an electrical characteristic of a circuit that includes the first irregular pattern, based on the estimated resistance of the first irregular pattern.

18. The system of claim 17, wherein slicing the first irregular pattern into a plurality of polygons generates polygons having two sides that are perpendicular to the rotation angle of the first irregular pattern.

19. The system of claim 17, wherein the computer program code and the at least one processor further cause the system to:
identify a second via in the first irregular pattern, and
wherein slicing the first irregular pattern into the plurality of polygons includes:
slicing the first irregular pattern into the plurality of polygons starting from a center of the first via and ending at a center of the second via.

20. The system of claim 17, wherein the computer program code and the at least one processor further cause the system to:
identify that the first irregular pattern includes the first via and is free of any other vias, and
wherein slicing the first irregular pattern into the plurality of polygons includes:
slicing the first irregular pattern into the plurality of polygons starting from a center of the first via and ending at an end of the first irregular pattern.
